(19) United States
(12) Patent Application Publication
(10) Pub. No.: US 2005/0163357 A1
(43) Pub. Date: Jul. 28, 2005

(54) Medical viewing system and image processing for integrated visualisation of medical data

(76) Inventors: Sherif Makram-Ebeid, Dampierre (FR); Jean-Michel Rouet, Paris (FR); Maxim Fradkin, Paris (FR)

Correspondence Address: PHILIPS INTELLECTUAL PROPERTY & STANDARDS, 595 MINER ROAD, CLEVELAND, OH, 44143, US

(21) Appl. No.: 10/515,362

(22) PCT Filed: May 15, 2003
(86) PCT No.: PCT/IB03/02078

(30) Foreign Application Priority Data
May 22, 2002 (EP) 02291263.8

(51) Int. Cl. G06K 9/00

(52) U.S. Cl. 382/128

(57) ABSTRACT

A medical viewing system comprising data acquisition means for acquiring image data in an image of an object surface and processing means for integrating clinical data with the image data, comprising processing means for processing the image data, whereby to identify a reference surface approximating the object surface and reference points on said reference surface; constructing a map, called distance map, comprising one or several distance transformed surface(s), from the reference surface, formed of image points that correspond univocally to reference points of the reference surface; estimating, at the location of the image points of the map, clinical data, and combining the clinical data and the image data at the location of the reference points, so that to integrate the clinical data in the image data; said medical viewing system further comprising image visualisation means for visualising the object images and/or the processed images.

### FIELD OF THE INVENTION

The present invention relates to a medical viewing system and to an image processing method for integrated visualisation of medical image data relating to an anatomical element. The invention further relates to a medical examination apparatus having such a medical viewing system and to a computer program product having instructions for carrying out the method steps. The invention finds its application in the field of medical imaging and, more especially, in the field of x-ray medical imaging.

### BACKGROUND OF THE INVENTION

A primary aim of medical imaging is to present medical image data in a form that is useful for the clinician. Initially this aim was fulfilled by providing the clinician with accurate representations of an anatomical feature of interest. There are many techniques now available for producing three-dimensional (3-D) medical image data representing anatomical features of interest to the medical practitioner. Various methods of processing and representing that medical image data have also developed. Increasingly, visualisation apparatus is interactive, allowing the clinician to control the view that is presented. Almost all techniques currently used to render and visualise 3-D medical image data depend on slicing or projecting data using conventional rectangular coordinates (x, y, z) of the image. The images may further be “re-sliced” in any oblique plane going through the volume. Other approaches make use of a “curved multi-planar reformatting” in which the x-axis is replaced by any curvilinear path seen in a planar cross-section of the image, while the other dimensions of the volume are unchanged. Other systems allow the user to extract active surface models closely fitting the boundaries of an organ as acquired in a 3-D medical image. As processing and visualisation techniques have become more sophisticated, it has become desirable to represent not only the anatomical feature of interest itself but, in addition, other associated clinical data. This associated clinical data could be:
additional clinical data associated with the surface of interest: for example, it could be useful to provide an image not only of the surface of the skull, but also of the thickness of bone at various points, or
additional anatomical image data relating to organs, vessels, etc. which are associated with the surface of interest: for example, on a representation of the heart it could be useful to represent, in addition, the coronary arteries.

An anatomical feature could be visualised together with a representation in numerical form of associated clinical data. However, the medical practitioner can more easily interpret the represented information if the clinical data are integrated into the visual representation that is made of the anatomical feature of interest. In the case of associated anatomical image data, clearly it is desirable to represent these additional data in a manner integrated with the representation of the anatomical feature of interest.

A publication entitled “Integrated Visualization of Quantitative Information with Anatomical Surfaces”, pp. 195-200, in “Computer Assisted Radiology, Proceedings of the International Symposium on Computer and Communication Systems for Image Guided Diagnosis and Therapy”, CAR'95, Berlin, Jun. 21-24, 1995, Springer, Karel, by Zuiderveld et al., proposes an approach for integrating visualizations of anatomical surfaces with quantitative data. According to the proposal of Zuiderveld et al, at numerous points over the anatomical surface of interest, the maximum, minimum or mean value of a given clinical is measured over a certain distance along the normal to the anatomical surface at that point. For each surface point, the clinical data of interest, mean, minimum, maximum, is evaluated by considering samples, for instance voxels, that are evenly spaced along the normal to the surface at that point, and that are within a certain distance from the surface. The calculation can take into account samples outside the surface of interest, which are said to be along the surface normal, and/or samples inside the surface of interest, which are said to be along the reverse surface normal. The measured clinical data are coded and integrated into the representation of the anatomical surface of interest as a texture on the displayed image, in this case by use of colour.

Unfortunately, when the technique proposed in the above-cited publication is applied, so as to integrate clinical data into a representation of a curved anatomical surface, the method is prone to produce an integrated representation, which is misleading, ambiguous, or impossible to interpret. It is particularly the case where the anatomical surface of interest has a generally spherical shape, and where a clinical data of interest is measured along different reverse normals to the surface, in order to be displayed at the points of intersection of said normals with the spherical surface. It has been found that first clinical data values measured on a first normal, for display at a respective first intersection point of the surface, may be influenced by second clinical data values measured on a second normal, when said second clinical data values are measured at particular locations on said second normal with respect to said first normal.

Incidentally, unless the contrary appears from the context, in the present document: the expressions “anatomical feature” and “anatomical surface” are intended to be read broadly so as to designate any feature or surface in the body, whether human or animal, whether a vessel, an organ, a part of a vessel or organ, or anything else, and include artificial elements implanted into or attached to the body; the expressions “clinical parameter data” and “clinical data” both designate data representing the value of one or more parameters of clinical interest, for example, rate of blood flow, thickness of surface, temperature, local blood perfusion, etc.; the expression “anatomical image data” and “image data” both designate image data representing the whole or a part of an anatomical feature; and the expression “surface normal” includes the reverse surface normal.

### SUMMARY OF THE INVENTION

The present invention has for an object to provide a medical viewing system having means for visualizing an anatomical surface of interest in an integrated fashion with associated clinical data, while avoiding various unwanted artefacts. In particular, the present invention has for an object to provide means of processing medical image data so as to enable improved integrated visualisation of a curved anatomical surface of interest and clinical data associated with that surface, and to avoid the problems inherent in the approach by Zuiderveld et al.

The technical features of such a medical viewing system are recited in claim 1.

The medical viewing system can be implemented as a specially programmed general-purpose computer. The medical viewing system can be a workstation. The present invention further provides an image processing method, which has steps to be performed by the processing means of the medical viewing system. This method comprises steps of processing medical image data for visualizing an anatomical surface of interest in an integrated fashion with associated clinical data, without unwanted artefacts. The present invention yet further provides a computer program product having a set of instructions, when in use on a general-purpose computer, to cause the computer to perform the steps of the above-described method. The present invention still further provides a medical examination apparatus incorporating medical imaging apparatus, data processing system putting into practice the above-described method to process medical image data obtained by the imaging apparatus, and means for visualising the image data produced by the method. The visualisation means typically consists of a monitor connected to the data processing apparatus. Advantageously, the workstation and medical imaging system of the present invention are interactive, allowing the user to influence clinical data that are evaluated and/or the manner in which evaluated data is to be visualised.

### BRIEF DESCRIPTION OF THE DRAWINGS

The invention and additional features, which may be optionally used to implement the invention to advantage, are described hereafter with reference to the schematic figures, where:

FIG. 1 is a diagram of a curved surface of interest and normals at two points of said surface;

FIG. 2 is a diagram illustrating basic components of an embodiment of medical viewing system, incorporated in a medical examination apparatus;

FIG. 3A and FIG. 3B are diagrams illustrating the construction of distance transform surfaces from the reference surface; and FIG. 3C illustrates the problem of magnification that is solved by the invention;

FIG. 4A is a flow diagram showing the main steps of a medical image data processing method according to a preferred embodiment of the invention; and FIG. 4B is a flow diagram illustrating in detail the steps 2 to 5 of FIG. 4A.

### DESCRIPTION OF EMBODIMENTS

The invention relates to a medical viewing system for the visualization of an anatomical surface of interest in an integrated fashion with associated clinical data. The present invention will be described in detail below with reference to embodiments applied to an integrated visualisation of curved surfaces of an organ together with other medical features or with clinical data. In the following detailed description, a preferred embodiment of the present invention will be described in which the anatomical feature of interest is the heart and it is the whole or a part of the surface of the epicardium (heart muscle) which is the principal anatomical surface to be visualised. However, the present invention can be applied to other curved anatomical_surfaces, such as the following curved surfaces: the inner surface of the right ventricle, the outside surface of a vessel, inside surface of the colon, etc. In a case where the anatomical surface to be visualised is the epicardium, it can be desirable to produce an integrated visualisation of this surface together with the coronary arteries, or together with clinical parameter data, e.g. rate of blood flow, relating to those arteries. The outside surface of the heart muscle can be extracted using known techniques, even in a coarse fashion, and a representation thereof generated, and clinical data relating to the coronary arteries can then be projected onto the coarse representation. The integrated representation provides useful data to the medical practitioner in a form that can be interpreted in an easy manner.

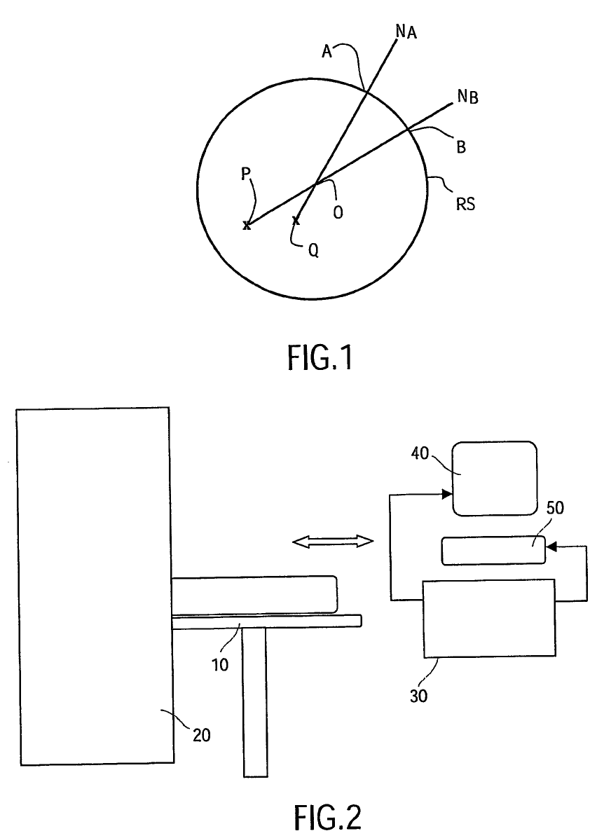

Although medical imaging technology is well developed, current techniques are inadequate when applied to the “visualisation of curved surfaces together with clinical data”. The problem can be better understood from consideration of FIG. 1 that represents a curved anatomical surface to be processed in an integrated fashion with associated clinical data. This anatomical surface of interest, RS, shows a generally spherical shape, giving a circular cross-section. It is assume that a clinical data of interest is measured along the reverse surface normals N_{A} and N_{B} in order to be displayed at two points A and B on the surface, as taught by the Zuiderveld et al. approach. If the Zuiderveld et al. approach is used, then the calculation for both points A, B can be affected by the value at point O, at the centre of the circle, where the surface normals cross. Thus, the value taken by the clinical data in question, at a given point, influences the final representation at two different locations, rendering the representation ambiguous. The problem is particularly acute in a case where it is the maximum or minimum of the clinical data that is being measured, and in the case where said maximum or minimum value occurs at point O. Moreover, if the clinical data of interest is evaluated inwards along the reverse surface normals N_{A} and N_{B} up to a distance that exceeds the radius of the circle, then the value at data point P can contribute to the surface representation at point B and the value at data point Q can contribute to the surface representation at point A. In such a case, the relative order of the points P, Q has been reversed when they are mapped onto the surface of interest. Thus, when using the Zuiderveld et al. approach, the resulting integrated visualisation of the surface together with the clinical data will be misleading.

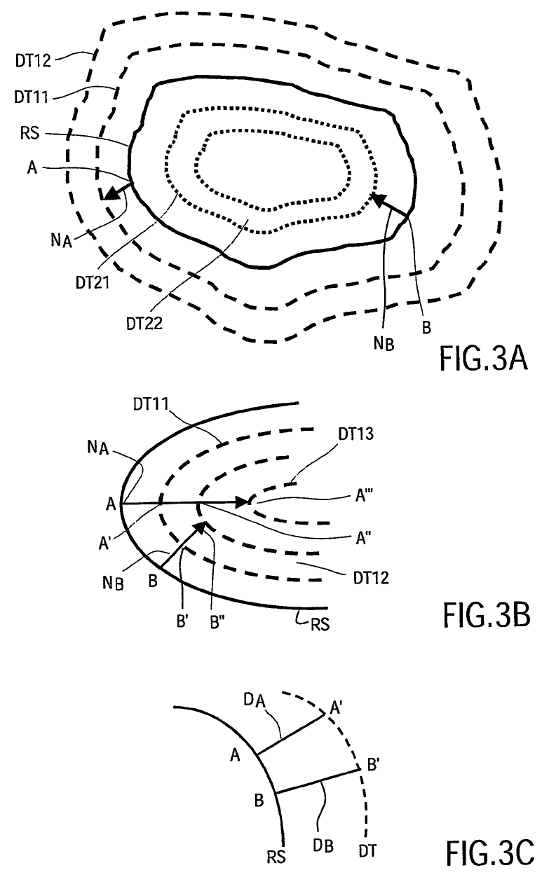

The medical viewing system and an image processing method of the present invention permits to avoid the artefacts produced by the Zuiderveld et al. approach. A preferred embodiment of the present invention will now be described with reference to FIGS. 2 to 4.

FIG. 2 shows the basic components of an embodiment of an image viewing system in accordance to the present invention, incorporated in a medical examination apparatus. As indicated schematically in FIG. 2, the medical examination apparatus typically includes a bed 10 on which the patient lies or another element for localising the patient relative to the imaging apparatus. The medical imaging apparatus may be a CT scanner 20. The image data produced by the CT scanner 20 is fed to data processing means 30, such as a general-purpose computer. The data processing means 30 is typically associated with a visualisation device, such as a monitor 40, and an input device 50, such as a keyboard, pointing device, etc. operative by the user so that he can interact with the system. The elements 10-50 constitute a medical examination apparatus according to the invention. The elements 30-50 constitute a medical viewing system according to the invention. The data processing device 30 is programmed to implement a method of analysing medical image data according to preferred embodiments of the invention.

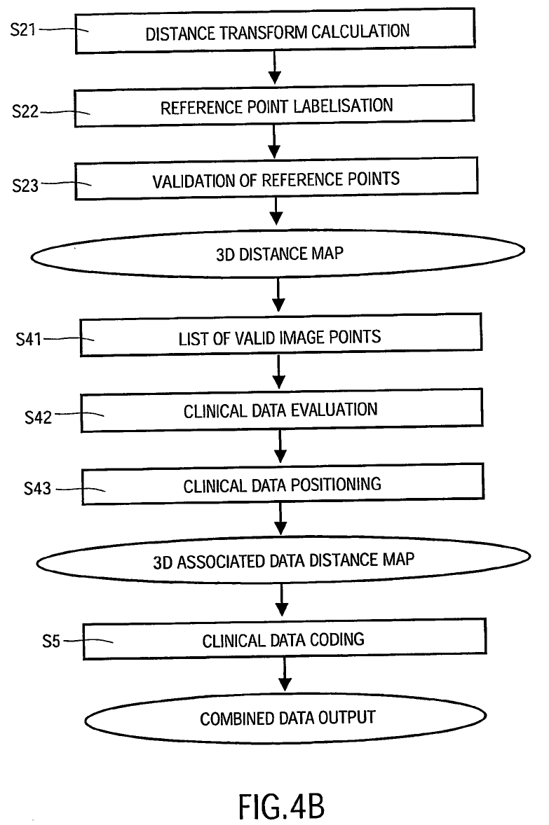

FIG. 4A is a flow diagram showing the steps in the preferred method of processing medical image data in order to enabling improved integrated visualisation of a curved anatomical surface and associated clinical data.

The image data input to the method is, in this example, 3-D computed tomography image data obtained for a subject heart is the image data input to the method. The medical image data consists of a large number of data relating to points (voxels), each corresponding to a respective position within the patient's body. The preferred method further comprises steps:

S0 for preprocessing the image data. In step S0, the input image data may be subjected to conventional pre-processing, for example, to eliminate noise.

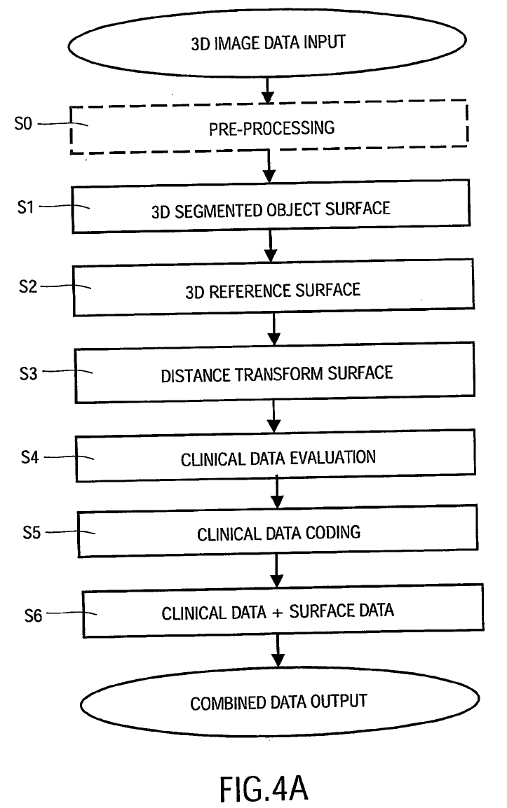

S1 for calculating a segmented object surface. In step S1, the outer surface of the heart muscle is identified from within the image data via a segmentation process as illustrated by the segmented curved surface RS in FIG. 3A to 3C. In the segmentation process, a 3-D surface is defined, which models the outer surface of the heart muscle. This 3-D segmented surface may be a surface defined by linking together points in the medical image data, which have the same intensity value, typically the same grey level, hence called iso-surface. This permits of segmenting the object with respect to a background that has a different grey level, or with respect to another organ. Alternately, this segmented surface may be obtained by linking together points that answer to a segmentation criterion. In another technique, the 3-D surface may be obtained as an active model providing a best fit to the heart muscle, or other anatomical object under consideration. Yet further, this 3-D surface can be user-defined, typically by operation of the pointing device or other user input device 50 shown in FIG. 2. Techniques for modelling a surface by an iso-surface are described, for example, in the “Handbook of Medical Imaging, Processing and Analysis”, edited by Isaac N. Bankman, Academic Press, chapter 5 “Overview and Fundamentals of Medical Image Segmentation” by Jadwiga Rogowska Techniques for producing an active model of an anatomical object are also well-known, for example by the description in the publication entitled “General Object Reconstruction Based on Simplex meshes” by Herve Delingette, in the International Journal of Computer Vision, 32, 111-142, 1999.

S2 for calculating a reference surface. In a step S2, the segmented object surface is processed to yield a 3-D simplified surface, which approximates the segmented object surface. Preferably, the segmented 3-D surface is smoothed, using known techniques, to remove corners or highly curved portions. The smoothed segmented surface is called “Reference Surface” and is denoted by RS hereafter.

Said simplified surface may be submitted, but not necessarily, to an operation of discretisation. In an embodiment, this operation permits of obtaining a 3-D surface closely approximated by a polyhedron referred to as “reference polyhedron”, wherein the 3-D simplified surface is decomposed into small elements, called “patches” or “facets”, which are not necessarily plane. In other embodiments, the reference surface RS can even be a mere approximation of the organ shape such as a sphere or an ellipsoid for the heart, a cylinder for the colon, etc.

If the reference polyhedron is used as reference surface, and shows plane facets, the normals to those facets are calculated. If the reference polyhedron is used as reference surface, and shows patches, the normals to those patches are approximated by an average normal. If the reference surface RS shows neither patches nor facets, the normals to a number of, or to all voxels, are estimated. This estimation is performed by calculating the tangent surface at each considered voxel and then by calculating the normal to this tangent surface. Each facet or each patch in the reference polyhedron, approximating the 3D segmented surface, can be characterised by the (x,y,z) Cartesian coordinates of its centroid, by the components (u,v,w) of the outward normal vector to the facet or patch, and by a set of adjacent neighbouring centroids. In other embodiments, each voxel of the simplified reference surface RS is also characterised by its (x,y,z) Cartesian coordinates, by the components (u,v,w) of an outward approximated normal vector at this point, and by a set of adjacent points on said simplified reference surface RS. The centroids, nodes or the considered voxels of the chosen surface of reference are called “Reference Points” hereafter.

Three-dimensional surface segmentation techniques, and techniques to discretise the surface, are well known and so will not be described in detail here. Further information on segmentation can be found in the “Handbook of Medical Imaging, Processing and Analysis”, editor-in-chief Isaac N. Bankman, Academic Press, chapter 5 “Overview and Fundamentals of Medical Image Segmentation” by Jadwiga Rogowska.

S3 for constructing a distance transform map. In step S3, surfaces, called “Distance Transform Surfaces”, denoted by DT, are calculated. These surfaces are distance transforms of the reference surface RS. The reference points of the reference surface are propagated as well as their labels, either outwardly by a dilation operation, or inwardly by a contraction operation, yielding one or several distance transform surfaces DT, each within a given distance from the reference surface RS. As illustrated by FIG. 3A, to a reference surface RS, correspond the outward distance transform surfaces DT11 and DT12, and the inward distance transform surfaces DT21 and DT22. To each reference point (A, B, etc.) of the reference surface RS corresponds a unique image point on each distance transform surface DT. Moreover, to each point on each distance transform surface DT, a label of its corresponding referencec point on the reference surface is assigned. As illustrated by FIG. 3B, to the reference point A of the reference surface RS, correspond image points A′, A″, A″′ on the distance transform surfaces DT11, DT12, DT13. Since these image points A′, A″, A″′ are located, on the normal N_{A} to the reference surface RS at the reference point A, and on the distance transform surfaces DT11, DT12, DT13, it results that these image points A′, A″, A″′ are located at given predetermined distances from said reference surface RS, and that these image points A′, A″, A″′ are respectively the unique correspondent of said reference point A on said distance transform surfaces DT11, DT12, DT13, etc.

In the same way, the normal NB at reference point B, shows the image points B′, B″ on the distance transform surfaces DT11, DT12, with the same properties.

In the present invention, clinical data are to be displayed associated with reference points, A or B, etc. These clinical data are evaluated at the location of the image points, A′ or B′; A″ or B″, etc, located along the normal N_{A} or N_{B}, etc, to the reference surface RS, at the intersection with the different distance transform surfaces DT, as described above and illustrated by FIG. 3A. Hence, the present invention departs from the Zuiderveld et al. approach, because the image points are not only located along a surface normal, but also on the different distance transform surfaces, at different given distances from the reference surface RS that are predetermined by the construction of said distance transform surfaces.

According to preferred embodiments of the invention, image points are determined along the surface normals corresponding to every reference points, at the intersection with the distance transform surfaces. So, an image point of a distance transform surface corresponds univocally to a reference point of the reference surface. The image points closest to the surface of interest are first identified, then the image points further and further away on the different distance transform surfaces are identified, as far as possible from the reference surface. Preferably the image points are selected both along the surface normal and along the reverse surface normal. The different identified image points corresponding to the reference point of the reference surface RS modelling the clinical surface of interest, located on said distance transform surfaces, will constitute a map of points, called “data distance map”, which is formed of image points surrounding the reference surface outwardly and inwardly.

The main advantages of the present invention stem from the creation of said “distance map”. The properties of the map are as follows: The map ensures the “uniqueness” of the image points with respect to the corresponding reference points, due to the fact that, in each distance transform surface, a single image data point corresponds to one reference point of the reference surface. The map ensures the “order conservation”, due to the fact that the relative positions of a first and a second image data points on any given distance transform surface, are the same as the relative positions of the corresponding first and second reference points on the reference surface.

However, further tests may be performed to better select the points of the map, in order to still improve the above-described imaging technique. Tests are proposed bellow for selecting the image points that will preferably be taken into account when making the evaluation of clinical data associated with a reference point. Among the proposed tests:

A magnification test: A first test called magnification test, illustrated by FIG. 3C, may be performed in order to ensure that the distances (in directions parallel to the surface of interest) between image data points that are taken into account when evaluating clinical data associated with reference points of the reference surface are kept within user-defined ratios. For instance, regarding the points A′, B′, which correspond to A, B, the magnification test has means for computing the value of A′B′/AB and for estimating whether said value is within a predetermined range of values, and means to eliminate the points that fail the test.

A distance test: A second test, called distance test, illustrated by FIG. 3B, may be performed in order to ensure that *each image data points, which is taken into account when evaluating clinical data, is associated with the closest reference point of the reference surface. This distance test is only needed when distance transform surfaces DT are created without a point labelling technique, such as the point labelling technique described above. Generally, according to the invention, it is sought to select points of the normals to the reference surface, which are on distance transform surfaces positioned as far as possible from the reference surface. However, the farthest found image point, which corresponds to a given reference point of the reference surface, must not be located nearer to another reference point than to its own corresponding reference point. For instance, the image point A″′ on DT13, which corresponds to the reference point A, would be nearer to the reference point B than to its own corresponding reference point A. The distance test ensures that such an image point A″′ cannot not be coupled with B when constructing the map. Hence, A″′ is discarded. This test gives the ultimate image point that is selected on a given normal.

It results from the application of these tests, that a number of image points of the distance map are deemed necessary to be rejected in order to improve the imaging technique. Hence, said “distance map”, may not have a uniform thickness or may not have the same thickness each side of the surface of reference.

The first three properties are inherent to the construction of the distance map, since in said construction, by dilation or contraction, each point of the constructed distance transform surfaces corresponds to a single original reference point, which ensure the uniqueness of the image points, the conservation of relative position of the image points and the conservation of shape of features formed of image points. Thanks to the use of the distance map, the present invention ensures that a single data point cannot give rise to data visualised at two different places on the anatomical surface of interest. Hence, the invention reduces ambiguity in the integrated representation of the anatomical surface of interest and the associated clinical data. Thanks to the use of the distance map, the present invention ensures that different clinical data items that are visualised in association with the anatomical surface of interest are in relative positions, which reflect the true relative positions of these data points in the patient's body. By rejecting image data points which fail the proposed magnification test, and/or which fail the distance test, the preferred embodiments of the present invention ensure that when the clinical data are visualised, the apparent size of any feature (e.g. a region of increased thickness) is not unduly exaggerated or minimised. According to the invention, the use of the map of data points permits to avoid artefacts that render the visualised image ambiguous.

S4 for evaluating the clinical data linked to the image points of the “distance map”. According to the present invention, the image data relating to the surface of interest are to be displayed in an integrated fashion with associated clinical data. Thus, it is necessary to determine which clinical data is to be visualised in association with the respective reference points A, B, etc. of the reference surface RS, approximating the surface of interest.

The clinical data for display are determined indifferently before or after performing an operation of surface rendering for providing said specific reference surface RS (reference polyhedron, simplified surface or any other kind of smoothed or discretised surface representative of the surface of interest), to be chosen as a support for displaying said data in an integrated manner, and to be constructed by using one of the above-described techniques.

In step S4 illustrated by FIG. 4A, the clinical data to be visualised in an integrated fashion with the reference surface are evaluated at the location of the selected image points of the “distance map” defined in step S3. This evaluation can calculate a value for various different clinical data, for example, the minimum intensity projection, the maximum intensity projection, the mean intensity projection, or the sum of intensities along the normal. The “minimum intensity projection” value for a given reference point is the lowest intensity value among the image points that are located along the normal at the reference point and that are within the “distance map” defined in step S3. The “maximum intensity projection” and the “mean intensity projection” and “sum of intensities” are self-explanatory.

The clinical data evaluated at the location of the image points of the “Distance Map”, further form an “Associated Data Distance Map” that wraps the reference surface outwardly and/or inwardly.

S5 for clinical data coding. In step S5, once the clinical data have been evaluated for the various image points of the “distance map”, the calculated values are encoded, for example into colour code values, to be visualised in an integrated fashion with the image data of the reference surface RS representing the clinical surface of interest. The clinical data can be encoded in a variety of ways, for example, using code values which produce different patterning, colour or texture on a display of the surface of interest. If colour coding is used, this can follow various approaches, for example a Red-Green-Blue (RGB) approach, or a hue-saturation-value (HSV) approach. The present invention is applicable regardless of the manner in which the clinical data are encoded and visualised in association with the reference surface.

S6 for combining data. In step S6, then, the encoded clinical data of the associated data distance map and the rendered surface data of the surface of reference representing the anatomical surface of interest are combined, so as to be output. So, the encoded clinical data evaluated at image points on a given normal are combined with the image data at the location of the corresponding reference point on the reference surface.

Image Data Output for Visualisation: In general, the combined output data are displayed on a display device such as the monitor 40 of the medical viewing system of FIG. 2. The evaluated clinical data can be time-varying data. For example, the rate of perfusion of a contrast product into the myocardium is of clinical interest. This can be represented by gathering image data over time, as the contrast product enters the myocardium, evaluating the maximum/minimum intensity projection along the normals at the different reference points of a reference surface approximating the myocardium at different moments, and colour encoding the calculated values. The user will obtain a representation of the myocardium with a changing pattern of colours showing the perfusion of the contrast product.

In a preferred embodiment, further described with reference to FIG. 4B, the method comprises sub-steps of the above-cited Step 2. In sub-step S21, the reference surface RS is constructed. In sub-step S22, the reference points are labelled. In a sub-step S23, the reference points are validated. A predetermined distance controls the resolution of the data to be visualised in association with the anatomical surface of interest. A limitation value may be set taking into account the clinical data of interest and anatomical considerations (if the distance is too large, data would be unduly considered, whereas they relates to organs or anatomical features other than those of interest). Then, each reference point of the reference surface is processed in turn and the normal to the reference surface is calculated at each reference point.

Then step S3, is performed as previously described. The “Distance Transform Surfaces” DT are constructed. The tests of selection of the image points forming the map are performed. At the end of the testing procedure described above, the distance map of valid image data points has been constructed in correspondence to the reference surface modelling the anatomical surface of interest.

In a preferred embodiment, described with reference to FIG. 4B, the method comprises sub-steps of the above-cited Step S4. In sub-step S41, a list of the valid image points is issued. In sub-step S42, clinical data are evaluated. The original medical image data are sampled at each of the valid data points. In general it is necessary to perform interpolation between voxels in the original image data, because the locations of image points does not necessarily coincide with the locations of the voxels in the original medical image data. In sub-step S43 the clinical data are positioned. The set of sampled data represents the valid data that can be analysed in association with respective points of the reference 3D surface, in order to evaluate clinical data that are to be visualised in an integrated fashion with the anatomical surface of interest. In a sub-step S44, the “Associated Data distance Map” is formed. The Associated Data distance Map represents a reformatting of the original medical image data, for instance a reformatted volume of image data.

In the above description, it is assumed that the clinical data and the associated anatomical surface of interest will be visualised in an integrated fashion in 3-D form. However, optionally, the reference 3-D surface can be flattened, the object interface can be estimated by representing it in the reformatted volume as a regular function (for example, B-spline) in the mathematically simple form: w=f(u,v), where w is the signed normal distance to the reference 3-D surface and (u,v) are the coordinates in the reference 3-D surface. Standard best-fit procedures can be used when working with this simplified representation. Alternatively, or additionally, the image intensities projected onto the flattened reference 3-D surface representation form a 2-D image that can provide useful information in its own right. For example, the 2-D image can be processed using known 2-D handling techniques in order to analyse vessel width or vessel stenosis, or in order to determine the vessel centreline.

In the above-described preferred embodiment, 3-D medical image data were obtained via computed tomography apparatus. It is to be understood that the present invention is applicable regardless of the medical imaging technology that is used to generate the initial data. For example, when seeking to visualise the heart, magnetic resonance (MR) coronary angiography may be used to generate 3D medical image data in a non-invasive manner. See, for example, “Non-invasive Coronary Angiography by Contrast-Enhanced Electron Beam Computed Tomography” by Achenbach et al, in Clinical Cardiology, 21, 323-330, 1998. The Achenbach et al article includes useful information regarding optional data processing steps that can be applied to the medical image data, for example, segmentation to enable a representation of certain anatomical features in isolation from others, details of shading techniques used to produce a displayed image, etc. These steps can be applied in the method of the present invention.

The present invention is applicable regardless of the way in which the anatomical surface of interest is modelled, whether via use of a reference polyhedron, use of a reference simplex mesh, or in some other way. Preferably, the anatomical surface of interest is merely identified in the image data via a segmentation step followed by a smoothing step, which provide the reference surface RS, and there is no specific modelling of the identified surface.

Various modifications can be made to the order in which processing steps are performed in the above-described specific embodiment. The above-described processing steps applied to medical image data can advantageously be combined with various other known processing/visualisation techniques. For example, it is known when modelling a surface by a reference polyhedron or mesh for image analysis and visualisation, to set the facet size adaptively, typically so that the facet sizes are not too large (which would give poor spatial resolution). It can be advantageous to apply this adaptive setting of facet size in the present invention for the same reason, as well as to avoid the case where each facet has few or no corresponding voxels.

The drawings and their description hereinbefore illustrate rather than limit the invention. It will be evident that there are numerous alternatives that fall within the scope of the appended claims. In this respect the following closing remarks are made.

Moreover, although the present invention has been described in terms of generating image data for display, the present invention is intended to cover substantially any form of visualisation of the image data including, but not limited to, display on a display device, and printing. Any reference sign in a claim should not be construed as limiting the claim.

1. A medical viewing system comprising,
data acquisition means for acquiring image data in an image of an object surface;
processing means for integrating clinical data with the image data, the processing means for integrating comprising
processing means for processing the image data to identify a reference surface approximating the object surface and reference points on said reference surface;
means for constructing a distance map comprising one or more distance transformed surface(s), from the reference surface, formed of image points that correspond univocally to reference points of the reference surface;
means for estimating, at the location of the image points of the map, clinical data, and
means for combining the clinical data and the image data at the location of the reference points, to integrate the clinical data in the image data; and
said medical viewing system further comprising image visualization means for visualizing the object images or the processed images.

2. A medical viewing system according to claim 1, further comprising processing means to encode the clinical data, so as to visually differentiate them from other data.

3. A medical viewing system according to claim 1, wherein the image points of the distance transformed surface(s) are each located at the intersection of a normal to the reference surface at a reference point and said distance transformed surface(s), whereby the transformation ensures the uniqueness of the corresponding points of the distance transformed surface(s) with respect to the reference points of the reference surface and the conservation of relative positions of the points of anatomical features.

4. A medical viewing system according to claim 3, further comprising
testing means for testing the image points of the distance map, among which a magnification test for estimating whether, in directions parallel to the reference surface, the ratio of the distance between two image points of a distance transform surface, to the distance between the corresponding points of the reference surface, is kept within a predetermined range; and
selection means for discarding points of said distance transform surface that fail the magnification test.

5. A medical viewing system according to claim 4, wherein the testing means for testing the image points of the distance map performs a distance test for estimating whether, in directions orthogonal to the reference surface, an image point on the normal to the reference surface, located on a distance transform surface, is closest to the corresponding reference point on the reference surface or closer to another reference point on said reference surface; and further comprising selection means for discarding points of said surface normal that fail the distance test.

6. A medical viewing system according to claim 5, further comprising,
processing means for computing clinical data at the location of the image points of the distance map, so as to form an associated data distance map;
means for combining said computed clinical data of the associated distance map with the image data of the corresponding reference points of the reference surface, so as the clinical data of image points on a given normal to the reference surface is combined with the image data of the reference point corresponding to said given normal; and
means for displaying respectively the combined data on the reference surface at the location of the corresponding reference points.

7. A medical viewing system according to claim 6, further comprising processing means for:
segmenting the image data whereby to identify the object surface of an original image;
approximating said segmented object surface data for determining the reference surface, which represents an approximated surface of said object surface devoid of folded portions;
determining reference points on the reference surface; and
calculating the normals to the reference surface at the reference points.

8. A medical viewing system according to claim 7, further comprising processing means for constructing distance transform surfaces from the reference surface, by dilation or contraction of the reference surface, so as to form a map of image points that is the distance map, and that wraps the reference surface outwardly or inwardly, each image points of the distance transform surfaces corresponding univocally to a reference point and being located at the intersection of a normal to the reference surface and a distance transform surface.

9. A medical viewing system according to claim 8, further comprising processing means for constructing the reference surface as a smoothed simplified surface from the segmented surface, and identifying the reference points as points of said smoothed simplified surface.

10. A medical viewing system according to claim 9, further comprising processing means for constructing the reference surface as a discretised surface from the smoothed simplified surface, said reference surface showing a plurality of facets or patches.

11. A medical viewing system according to claim 10, further comprising processing means for generating a flattened 2-D representation of said reference surface.

12. An image processing method to cause the data processing means of the medical viewing system of claim 1 to perform the steps of acquiring and processing image data in an object image of an object, for integrating clinical data with the image data, wherein processing comprises:
processing the image data, whereby to identify a reference surface approximating the object surface and reference points on said reference surface;
constructing a distance map comprising one or more distance transformed surface(s), from the reference surface, formed of image points that correspond univocally to reference points of the reference surface;
estimating, at the location of the image points of the map, clinical data,
combining the clinical data and the image data at the location of the reference points, so that to integrate the clinical data in the image data; and
visualising the object images or the processed images.

13. A medical examination apparatus according to claim 1, further comprising acquisition means for acquiring medical image data and imaging means for displaying the medical images.

14. A computer program product having a set of instructions, when in use on a general-purpose computer, to cause the computer to perform the steps of the method according to claim 12.
